(19) United States
(12) Patent Application Publication
(10) Pub. No.: US 2020/0394605 A1
(43) Pub. Date: Dec. 17, 2020

(54) DYNAMIC RISK-BASED PACKAGE DELIVERY

(71) Applicant: International Business Machines Corporation, Armonk, NY (US)

(72) Inventors: Stan Kevin Daley, Atlanta, GA (US); Michael Bender, Rye Brook, NY (US); Kulvir Singh Bhogal, Fort Worth, TX (US); Jeremy R. Fox, Georgetown, TX (US)

(21) Appl. No.: 16/438,905

(22) Filed: Jun. 12, 2019

(51) Int. Cl. G06Q 10/08; G06Q 10/06

(52) U.S. Cl. CPC G06Q 10/0833; G06Q 10/0635

(57) ABSTRACT

A method for reduction of home-delivered package theft is provided. The method identifies a set of characteristics for a first set of packages delivered by one or more distributors. The method identifies a subset of packages of the set of packages having a negative delivery status indicating a package is undelivered. Based on the subset of packages with the negative delivery status, the method determines a risk matrix for package delivery by the one or more distributors. Based on the risk matrix, the method generates a set of delivery plans for delivery of a second set of packages by the one or more distributors. The second set of packages have a set of delivery characteristics. The method then selects a delivery plan from the set of delivery plans based on the risk matrix and the set of delivery characteristics of the second set of packages.

### BACKGROUND

The present disclosure relates generally to methods for dynamic package delivery, but not exclusively, to a computer-implemented method for risk-based scheduling and delivery option modification to reduce home-delivered package theft.

Package tracking systems enable customers and delivery services to track packages being shipped and delivered. Package tracking systems generally update a status of a package. Some package tracking systems use sensors connected to packages to identify package locations and facilitate package tracking.

### SUMMARY

According to an embodiment described herein, a computer-implemented method for reduction of home-delivered package theft is provided. The method identifies a set of characteristics for a first set of packages delivered by one or more distributors. The method identifies a subset of packages of the set of packages having a negative delivery status. The negative delivery status indicates a package is undelivered to a designated recipient for the package. Based on the subset of packages with the negative delivery status, the method determines a risk matrix for package delivery by the one or more distributors. Based on the risk matrix, the method generates a set of delivery plans for delivery of a second set of packages by the one or more distributors. The second set of packages have a set of delivery characteristics. The method selects a delivery plan from the set of delivery plans based on the risk matrix and the set of delivery characteristics of the second set of packages.

### BRIEF DESCRIPTION OF THE DRAWINGS

FIG. 1 depicts a block diagram of a computing environment for implementing concepts and computer-based methods, according to at least one embodiment.

FIG. 2 depicts a flow diagram of a computer-implemented method for dynamic package delivery, according to at least one embodiment.

FIG. 3 depicts a flow diagram of a computer-implemented method for dynamic package delivery, according to at least one embodiment.

FIG. 4 depicts a flow diagram of a computer-implemented method for dynamic package delivery, according to at least one embodiment.

FIG. 5 depicts a block diagram of a computing system for task deployment, according to at least one embodiment.

FIG. 6 is a schematic diagram of a cloud computing environment in which inventive concepts of the present disclosure may be implemented, in accordance with an embodiment of the present disclosure.

FIG. 7 is a diagram of model layers of a cloud computing environment in which inventive concepts of the present disclosure may be implemented, in accordance with an embodiment of the present disclosure.

### DETAILED DESCRIPTION

The present disclosure relates generally to methods for dynamic package delivery, but not exclusively, to a computer-implemented method for risk-based scheduling and delivery option modification to reduce home-delivered package theft. The present disclosure relates further to a related system for dynamic package delivery, and a computer program product.

Online shopping with home delivery of purchased goods has been growing steadily of the last decade. This growth has resulted in the number of packages delivered to customers each year increasing at a rate of around five percent per year. Along with this growth, package theft has also increased. In recent years, eleven million people in the United States experienced a theft of a package from a home or workplace. These packages were often delivered to residences or workplaces with delivery confirmed by package scan, but without a signature. Thus, many packages are scanned by a delivery employee, but are left in locations outside of the residence or workplace, such as a doorstep. Due to the increasing number of deliveries and increasing value of packages, responding to package theft through insurance, loss prevention, or other standard techniques represents an increased cost to both consumers and vendors.

Theft of packages delivered to residences is common. Single package theft is often a crime of opportunity. Multiple package theft is also common, such as stealing multiple packages delivered simultaneously to a residence or following a delivery vehicle and collecting multiple packages along a delivery route. Currently, delivery services do not know where criminal activity is likely to occur nor what kind of packages an individual is targeting. Further, delivery services have limited capability or recourse in responding to reports of theft regardless of the timing of such reports. Therefore, delivery services typically have limited precautionary actions based on these known or unknown risk factors. In addition, delivery services do not generally share data associated with theft and other risks, limiting the ability of all delivery services working within an area from developing or implementing suitable risk mitigation practices.

Embodiments of the present disclosure provide methods, systems, and program products which analyze and dynamically respond to risk factors related to package loading, scheduling, and delivery. The present disclosure provides techniques and products for defining risks of package theft and enabling collaborative risk mitigation for package delivery. Some risks mitigated by embodiments of the present disclosure include financial impact to package distributors from content loss and incremental tracking costs. The present disclosure also enables mitigation of financial risk to shippers from content and insurance. The present disclosure mitigates lowering of customer satisfaction from working to replace stolen packages and untimely package delivery. Further, embodiments of the present disclosure help mitigate supply chain risks for replaceable or irreplaceable products.

Embodiments of the present disclosure provide a technical solution for dynamic package delivery, risk mitigation, and theft avoidance. As will be discussed in more detail below, embodiments of the present disclosure provide methods and systems to quantify risk events and identify potential risk of theft once a package is delivered to a destination. Embodiments of the present disclosure may use cognitive analysis of multiple data sources to identify products which were stolen, a time of theft, and a location of the theft. Further, embodiments of the present disclosure may identify a potential risk event score for future package deliveries. When a risk score of a package crosses a likelihood threshold, embodiments of the present disclosure may modify a delivery practice, schedule, or other delivery characteristic to mitigate the identified risk in a real-time environment.

According to an embodiment described herein, a computer-implemented method for reduction of home-delivered package theft is provided. The method identifies a set of characteristics for a first set of packages delivered by one or more distributors. The method identifies a subset of packages of the set of packages having a negative delivery status. The negative delivery status indicates a package is undelivered to a designated recipient for the package. Based on the subset of packages with the negative delivery status, the method determines a risk matrix for package delivery by the one or more distributors. Based on the risk matrix, the method generates a set of delivery plans for delivery of a second set of packages by the one or more distributors. The second set of packages have a set of delivery characteristics. The method selects a delivery plan from the set of delivery plans based on the risk matrix and the set of delivery characteristics of the second set of packages

In some embodiments, the method generates a set of loading plans for organizing the second set of packages within a delivery vehicle. Each loading plan of the set of loading plans may correspond with at least one delivery plan of the set of delivery plans. The method may select a loading plan of the set of loading plans based on selection of the delivery plan. The selected loading plan may be a loading plan associated with the selected delivery plan.

In some embodiments, determining the risk matrix further comprises determining a subset of common characteristics for the subset of packages having the negative delivery status. The method determines a delivery probability value for each characteristic of the subset of common characteristics.

In some embodiments, generating the set of delivery plans for the second set of packages further comprises determining one or more modifiable characteristics of the set of delivery characteristics for the second set of packages. The method determines, for each delivery plan, a delivery probability for each package of the second set of packages based on the risk matrix and modification of at least one delivery characteristic.

In some embodiments, the method modifies one or more delivery characteristics. Modification of delivery characteristics may be performed based on selection of a delivery plan. Such modifications may generate modified delivery characteristics for at least a portion of the second set of packages. In response to modifying the one or more delivery characteristics, the method determines a designated recipient for each package of the portion of the second set of packages associated with the modified delivery characteristics. For each package of the portion of the second set of packages, the method generates a change notification indicating the modified delivery characteristics for that package. The method then transmits the change notification for each package to the designated recipient associated with that package.

In some embodiments, the method monitors a delivery status of the second set of packages as the second set of packages are being delivered. Based on the monitoring, the method identifies a delivery anomaly indicating negative delivery of a portion of the second set of packages. Based on the delivery anomaly, the method modifies a delivery plan for the second set of packages to generate a modified delivery plan. The method then notifies the one or more distributors of the modified delivery plan.

Some embodiments of the inventive concepts described herein may take the form of a system or a computer program product. For example, a computer program product may store program instructions that, when executed by one or more processors of a computing system, cause the computing system to perform operations described above with respect to the computer implemented method. By way of further example, the system may comprise components, such as processors and computer readable storage media. The computer readable storage media may interact with other components of the system to cause the system to execute program instructions comprising operations of the computer implemented method, described herein. For the purpose of this description, a computer-usable or computer-readable medium may be any apparatus that may contain means for storing, communicating, propagating or transporting the program for use, by, or in connection, with the instruction execution system, apparatus, or device.

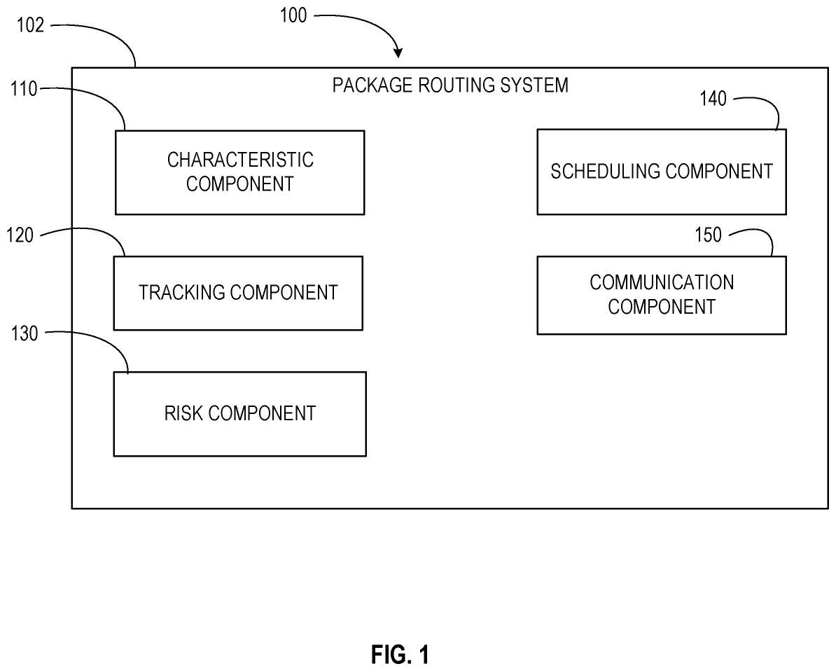

Referring now to FIG. 1, a block diagram of an example computing environment 100 is shown. The present disclosure may be implemented within the example computing environment 100. In some embodiments, the computing environment 100 may be included within or embodied by a computer system, described below. The computing environment 100 may comprise a package routing system 102. The package routing system 102 may comprise a characteristic component 110, a tracking component 120, a risk component 130, a scheduling component 140, and a communication component 150. The characteristic component 110 identifies characteristics of packages and deliveries and modifies characteristics of packages to be delivered. The tracking component 120 tracks delivery statuses of packages and distribution vehicles and determines designated recipients for packages. The risk component 130 determines risk matrices from package characteristics and delivery probabilities. The scheduling component 140 generates delivery plans for package delivery by distributors and loading plans for organization and orientation of packages within distributor vehicles to facilitate delivery plans with driver efficiency and timeliness while reducing package theft probabilities. The communication component 150 generates and transmits communications and notifications to distributors and designated recipients of packages. Although described with distinct components, it should be understood that, in at least some embodiments, components may be combined or divided, or additional components may be added, without departing from the scope of the present disclosure.

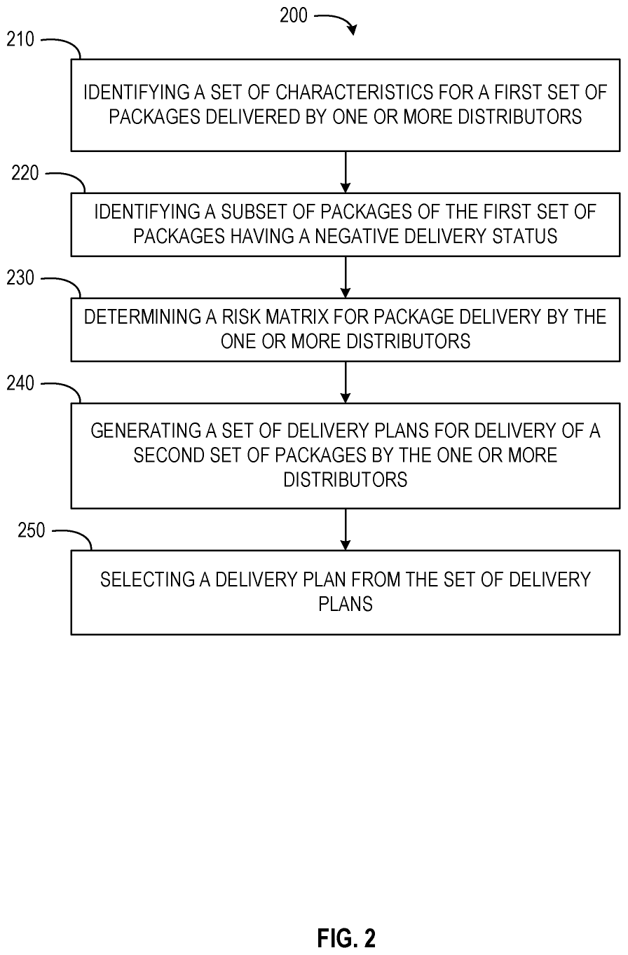

Referring now to FIG. 2, a flow diagram of a computer-implemented method 200 is shown. The computer-implemented method 200 is a method for dynamic package delivery with theft risk mitigation and package scheduling. In some embodiments, the computer-implemented method 200 may be performed by one or more components of the computing environment 100, as described in more detail below.

At operation 210, the characteristic component 110 identifies a set of characteristics for a first set of packages delivered by one or more distributors. In some embodiments, the set of characteristics for the first set of packages includes one or more of a signature requirement, a delivery time, a delivery location, a drop off location, street visibility of the drop off location, package value or cost, visibility of markings, time confirmed by recipient, size and dimensions of package, delivery signature received, delivery scan registering package delivery, delivery vehicle markings, delivery vehicle type, delivery route, driver identification, combinations thereof, or any other suitable characteristics describing or defining aspects of the package and delivery circumstances for the package. In some embodiments, the set of characteristics include environmental conditions such as time of day, sunset time, sunrise time, weather conditions, time of year, foliage conditions, and other suitable environmental conditions. The package markings and visibility of markings may include branding marks for the package, branding of the delivery service, branding of a product within the packaging, and other package markings. For example, branding of a package may include a brand name of a television manufacturer, delivery service, or shipping service. Delivery vehicle markings may include indications that the vehicle is unmarked, the vehicle has general markings or characteristics of a delivery vehicle (e.g., a box truck or mail delivery vehicle), or has branding or markings of a specified delivery service, distributor, or carrier. Delivery location and drop off location characteristics may include a type of address (e.g., residential, business, apartment), a location at which the package was delivered (e.g., front door, patio, side door, garage), and information indicating delivery placement for obfuscation (e.g., behind a bush, behind a patio chair, in mail box), and other characteristics defining aspects of the delivery.

The characteristic component 110 may identify the set of characteristics by parsing delivery information provided to the package routing system 102 by the one or more distributors or delivery services. For example, a delivery service interacting with the package routing system 102 may provide information on all deliveries performed by the delivery service, a portion of deliveries for specified areas, a portion of deliveries for specified times, a portion of deliveries for specified types of packages or delivery locations, or combinations thereof. In some embodiments, the set of characteristics may be automatically provided to the characteristic component 110 upon package delivery, at intervals (e.g., daily, monthly, quarterly), upon determination of thefts occurring within a delivery route or location, combinations thereof, or based on any suitable trigger. The characteristic component 110 may pass the set of characteristics, the delivery information, combinations thereof, or portions thereof to one or more components of the package routing system 102. The characteristic component 110 may also identify at least a portion of the set of characteristics by image analysis performed when packages are received for shipping by a delivery service or distributor.

The set of characteristics may also be provided to the characteristic component 110 by recipients of packages. In some embodiments, the characteristic component 110 is provided access to one or more package information databases containing information of one or more delivery services or distributors. The characteristic data provided to or accessed by the characteristic component 110 may be scrubbed of personally identifying information, sensitive information, confidential information, or any other type of information not appropriate to identify or determine theft risk. Data provided to or accessed by the characteristic component 110 may be subject to opt-in selections by users or customers of the delivery services or distributors or by designated employees of the delivery services or distributors. In some instances, users, customers, or employees are notified of opt-out options to remove their package information from being accessible by or provided to the characteristic component 110.

At operation 220, the tracking component 120 identifies a subset of packages of the set of packages having a negative delivery status. In some embodiments, the negative delivery status indicates a package undelivered to a designated recipient for the package. The negative delivery status may be determined, and logged into the delivery information for a package, based on an individual complaint (e.g., a registration of loss or theft to the delivery service or distributor), home security, facility security, a package with sensors (e.g., global positioning sensors, internet of things sensors, etc.), police report, combinations thereof, or any other suitable reporting or negative delivery status logging.

The tracking component 120 may identify the subset of packages by analyzing the delivery information provided to the characteristic component 110. In some instances, the characteristic component 110 may transfer delivery information to the tracking component 120 for identification of the subset of packages. The tracking component 120 may identify the subset of packages by parsing the delivery information, searching for a delivery tag. The delivery tag may be included in the delivery information about each package, in metadata associated with package data, or in any other suitable data storage. The delivery tag may indicate positive or negative delivery status. The delivery tag may be a bit indicating negative delivery status, where absence of the bit indicates successful delivery.

In some embodiments, the negative delivery status may indicate one or more reasons for a delivery failure for the package. In these embodiments, negative delivery status may indicate package theft, package rejection, wrong address, or any other suitable reason a package may be rejected, or delivery of a package may have failed. In such instances, the tracking component 120 may identify packages with a negative delivery status representing theft and disregard other forms of delivery failures. The tracking component 120 may pass the negative delivery status, delivery information for packages with the negative delivery status, combinations thereof, or portions thereof to one or more components of the package routing system 102.

At operation 230, the risk component 130 determines a risk matrix for package delivery by the one or more distributors. In some embodiments, the risk matrix is determined based on the subset of packages with the negative delivery status. The risk matrix may be determined by cross referencing missing or stolen packages against all deliveries and the set of characteristics to determine or detect a pattern. The pattern may be a geographical pattern, a route pattern, a characteristic pattern, combinations thereof, or any other suitable pattern. The pattern may account for loaded parameters. In some instances, the pattern may include a crime statistics corpus indicating theft locations and other suitable information. Where the pattern includes the crime statistics corpus, the risk component 130 may incorporate external data, such as police reports, neighborhood watch programs, or any other suitable data indicative of theft or criminal activity applicable to the risk component 130 and a generated risk matrix indicating likelihood of package theft.

In some embodiments, to determine the risk matrix, the risk component 130 determines a subset of common characteristics for the subset of packages having the negative delivery status. The risk component 130 may identify all characteristics of the subset of packages and eliminate or remove from consideration characteristics which are not shared by two or more packages of the subset of packages. In some instances, the common characteristics are weighted or marked based on a number of packages of the subset of packages which share the common characteristics. For example, a characteristic (e.g., branding marking an exterior of a package) shared by all packages of the subset of packages may be more heavily weighted than a characteristic (e.g., drop off location behind a bush) shared by two packages of a subset of three hundred packages.

The risk component 130 may determine a delivery probability for each characteristic of the subset of common characteristics. In some embodiments, the delivery probability is determined as a numerical value assigned to each characteristic based on a positive or negative effect the characteristic has on the risk of theft, a frequency of the common characteristic occurring within the subset of packages, or any other suitable risk quantification. In some embodiments, the risk component 130 determines the delivery probability by comparing the subset of common characteristics with the set of characteristics using cognitive analysis, machine learning, neural networking, convolutional neural networks, fully convolutional neural networks, fully connected neural networks, combinations thereof, or any other suitable process or method for analyzing probabilities in comparative data sets. In some embodiments, the risk component 130 incorporates historical statistics, theft statistics, and any other suitable statistical information with the subset of common characteristics, and the set of characteristics to determine delivery probability of individual characteristics for the risk matrix.

At operation 240, the scheduling component 140 generates a set of delivery plans for delivery of a second set of packages by the one or more distributors. In some embodiments, the second set of packages have a set of delivery characteristics. The set of delivery plans may be generated, at least in part, based on the risk matrix. The scheduling component 140 may be formed by or include a cognitive analysis engine. The cognitive analysis engine may include cognitive analysis, machine learning, neural networking, convolutional neural networks, fully convolutional neural networks, fully connected neural networks, combinations thereof, or any other suitable process or method for analyzing probabilities in comparative data sets. The scheduling component 140 may receive, as input, the risk matrix, delivery probabilities, delivery probabilities and associated characteristics, a crime corpus, information regarding the second set of packages (e.g., a second set of characteristics defining or describing attributes of the second set of packages), combinations thereof, and any other suitable information. The scheduling component 140 manipulates one or more delivery characteristics for each package of the second set of packages to generate the set of delivery plans.

Each delivery plan of the set of delivery plans may represent a reduction in risk or increase in delivery probability for at least a portion of the packages of the second set of packages. In some embodiments, each delivery plan indicates an efficiency impact (e.g., a measure or quantification of a cost to time, efficiency, and money) caused to the delivery route, the delivery vehicle, or other factors relating to package delivery. The delivery plans may indicate differing delivery routes, differing delivery locations, differing drop off locations, differing vehicle options or suggestions, combinations thereof, and any other suitable information affecting delivery of the second set of packages.

In some embodiments, the scheduling component 140 determines one or more modifiable characteristics of the set of delivery characteristics for the second set of packages. At least a portion of the modifiable characteristics may map to common characteristics used by the risk component 130 in generating the risk matrix. In these instances, the modifiable characteristics may be associated with differing delivery probabilities. Modification of the modifiable characteristics may increase or decrease the delivery probabilities for at least a portion of the packages. For example, modifiable characteristics may include time of delivery, visibility from a street, a signature requirement, a delivery location (e.g., residential delivery, workplace delivery, or pickup from a depo), or any other suitable characteristics. In some instances, the modifiable characteristics are designated as modifiable by designated recipients of individual packages or groups of packages. Where recipients designate characteristics as modifiable, the designation may indicate a range of modification acceptable to the recipient. In such embodiments, the scheduling component 140 may manipulate the one or more modifiable characteristics within the designated range. Modifiable characteristics may include vehicle type or drone. In some instances, vehicle related modifiable characteristics may be determined or selected based on availability of a suitable delivery vehicle. Modifiable characteristics may include a secondary drop off or delivery location where selected by a recipient or suggested by the risk component 130.

For each delivery plan, the scheduling component 140 determines a delivery probability for each package of the second set of packages based on the risk matrix and modification of at least one delivery characteristic. For each package or groups of packages, differing delivery plans may prioritize delivery options such that the lowest risk to highest risk delivery options are known or defined by the delivery plan, given the modifiable characteristics and any designated ranges. In some embodiments, the scheduling component 140 may incorporate differing delivery options when an individual package or group of packages exceeds a specified risk threshold. The risk threshold may be designated by a seller, a shipper, a recipient, an insurer, combinations thereof, or any other suitable interested party. In some instances, the risk threshold is automatically designated by the package routing system 102.

In some embodiments, for each delivery plan, the scheduling component 140 generates a set of loading plans for organizing the second set of packages within a delivery vehicle. Each loading plan of the set of loading plans may correspond with at least one delivery plan of the set of delivery plans. Each loading plan may include one or more of an order, organization, distribution, and orientation of the packages within a designated delivery vehicle or vehicles. In some instances, the loading plans are generated based on an order of delivery of the second set of packages defined by a delivery plan with which the loading plan is associated.

At operation 250, the scheduling component 140 selects a delivery plan from the set of delivery plans based on the risk matrix and the set of delivery characteristics of the second set of packages. The scheduling component 140 may select the delivery plan based on a prioritization of packages to be delivered, delivery probabilities for individual packages or combinations of packages, or based on a rating of all packages to be delivered within the second set of packages. In some instances, the scheduling component 140 selects the delivery plan, at least in part, on a rating of packages against a risk for each package and the risk based on changing one or more delivery characteristics or modifiable characteristics. In embodiments where the scheduling component 140 generates the set of loading plans for the set of delivery plans, the scheduling component 140 selects a loading plan of the set of loading plans based on selection of the delivery plan.

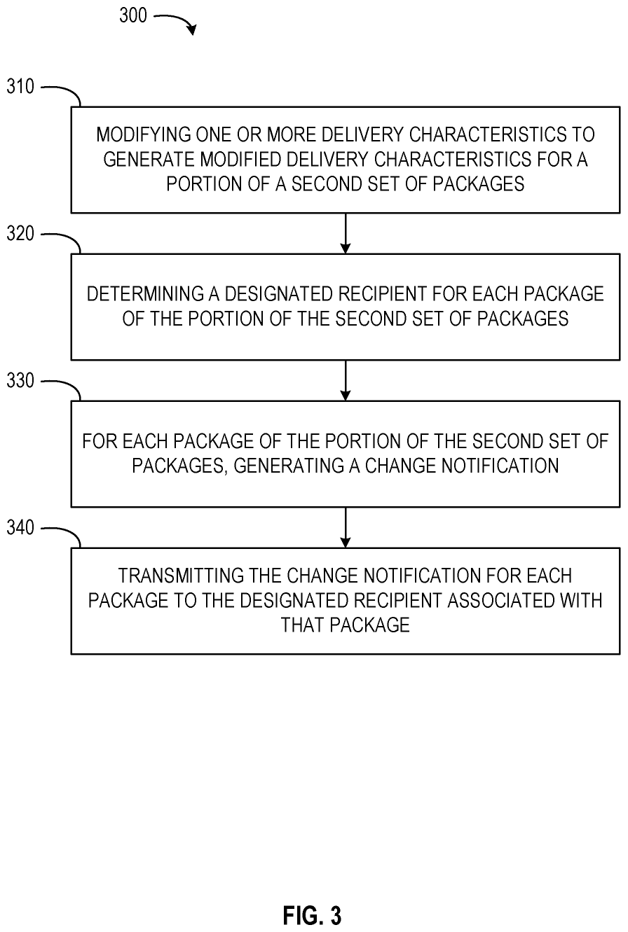

FIG. 3 shows a flow diagram of an embodiment of a computer-implemented method 300 for dynamic package delivery with theft risk mitigation and package scheduling. The method 300 may be performed by or within the computing environment 100. In some embodiments, the method 300 comprises or incorporates one or more operations of the method 200. In some instances, operations of the method 300 may be incorporated as part of or sub-operations of the method 200.

In operation 310, the characteristic component 110 modifies one or more delivery characteristics to generate modified delivery characteristics for at least a portion of a second set of packages. In some embodiments, the characteristic component 110 modifies the delivery characteristics based on selection of the delivery plan. The characteristic component 110 may generate the modified characteristics by transmitting the modification or the modified characteristic to the delivery system or database associated with a delivery service responsible for delivering the set of packages. Modification of the delivery characteristics may be performed within the package routing system 102, one or more delivery systems of a distributor or delivery service, combinations thereof, or any other suitable system. For example, where a set of packages is being delivered by “distributor A”, the characteristic component 110 may modify the one or more delivery characteristics within a delivery system or database of “distributor A.” Where the modified delivery characteristic is a signature requirement, the characteristic component 110 may override a no-signature required option if a risk of theft crosses a threshold where a new delivery option employing a signature requirement mitigates the risk or a value of the package is relatively high or exceeds a value threshold.

In operation 320, the tracking component 120 determines a designated recipient for each package of the portion of the second set of packages associated with the modified delivery characteristics. In some embodiments, the tracking component 120 determines the designated recipient in response to the characteristic component 110 modifying the one or more delivery characteristics. The tracking component 120 may determine the designated recipients as individuals or groups associated with packages associated with a modified delivery characteristic which affects one or more of a delivery location, a delivery time, and a delivery interaction (e.g., a delivery signature or pick up).

In operation 330, for each package of the portion of the second set of packages, the communication component 150 generates a change notification indicating the modified delivery characteristics for that package. The change notification may include a packaging information (e.g., a tracking number), an original delivery characteristic for the package for which the change notification is generated, and the modified delivery characteristic. In some instances, the change notification includes instructions representing actions to be taken by the designated recipient of a package based on the modified delivery characteristics for the package. For example, where the modified delivery characteristic changes a signature requirement for the package, the designated recipient may be instructed that a signature is required for delivery of the package due to theft risk.

In operation 340, the communication component 150 transmits the change notification for each package to the designated recipient associated with that package. In some embodiments, transmission of the change notification prompts acceptance of the change by the designated recipient. The change notification may also allow the designated recipient to accept the risk identified by the package routing system 102 to deny or revert the change. The communication component 150 may transmit the change notification to a contact channel (e.g., telephone number, mobile phone number, email address) associated with the designated recipient. In some instances, the communication component 150 transmits the change notification by passing the change notification to a delivery system or database associated with the delivery service or distributor responsible for delivering the package to the designated recipient. In those embodiments, the delivery system may finalize transmission of the change notification through accepted communication channels between the designated recipient and the delivery service or distributor.

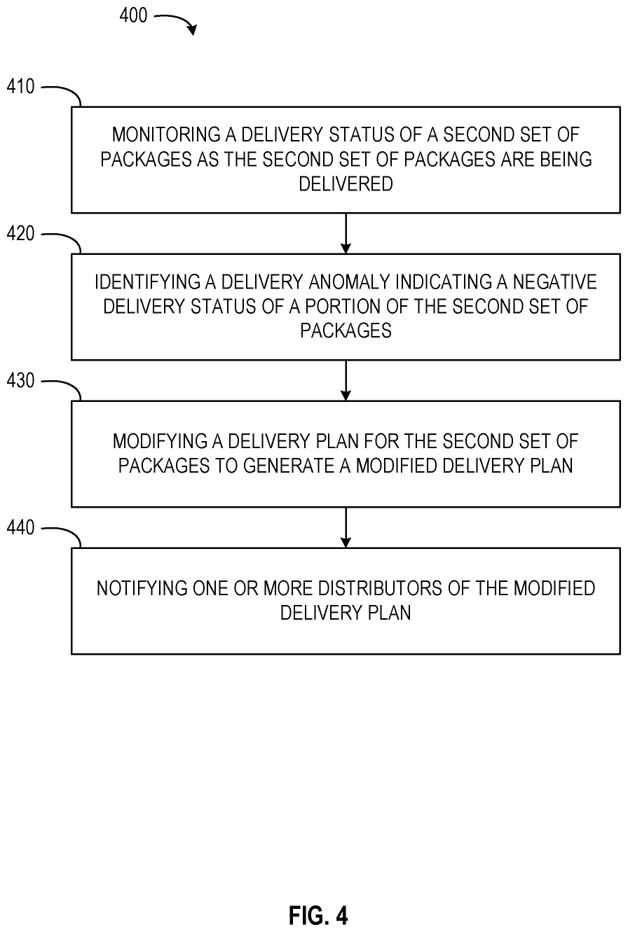

FIG. 4 shows a flow diagram of an embodiment of a computer-implemented method 400 for dynamic package delivery with theft risk mitigation and package scheduling. The method 400 may be performed by or within the computing environment 100. In some embodiments, the method 400 comprises or incorporates one or more operations of the methods 200 or 300. In some instances, operations of the method 400 may be incorporated as part of or sub-operations of the methods 200 or 300.

In operation 410, the tracking component 120 monitors a delivery status of the second set of packages as the second set of packages are being delivered. In some embodiments, the tracking component 120 monitors the delivery status of packages using sensors secured to or within the packages. The tracking component 120 may also monitor delivery status based on customer input, police input, and any other suitable input methods.

In operation 420, the risk component 130 identifies a delivery anomaly indicating a negative delivery status of a portion of the second set of packages. In some embodiments, the risk component 130 identifies the delivery anomaly based on the tracking component 120 monitoring the delivery status. Delivery anomalies may be understood as indications of missing or nondelivered packages. For example, a rash of reports that packages from a single vehicle are being stolen or failed to be delivered may indicate an anomaly of a thief following the single vehicle. In some embodiments, tracking and determination of delivery anomalies may be based on or similar to operations described above in method 200. The risk component 130 may identify a delivery anomaly where a risk of theft or non-delivery of packages rises above a specified risk level or threshold during delivery of the set of packages in real-time. Where the risk component 130 detects the delivery anomaly, the risk component 130 may transmit the delivery anomaly or an indication thereof to the scheduling component 140.

In operation 430, the scheduling component 140 modifies a delivery plan for the second set of packages to generate a modified delivery plan. In some embodiments, generation of the modified delivery plan is based on identification of the delivery anomaly. The scheduling component 140 may begin delivery of the second set of packages with the delivery plan selected in operation 250. The scheduling component 140 may have initially selected a loading plan corresponding to the selected delivery plan. Upon receiving the delivery anomaly from the risk component 130, the scheduling component 140 may select a different delivery plan (e.g., a second delivery plan) from the set of delivery plans. The second delivery plan may represent a decrease in risk from the delivery anomaly to a level below a specified risk threshold. In some instances, the second delivery plan may be selected by removing delivery plans from the set of delivery plans which fail to mitigate or sufficiently reduce the risk level. The second delivery plan may also be selected or generated by modifying the existing delivery plan to reduce the risk level below the risk threshold. For example, the second delivery plan may modify delivery characteristics for a portion of the packages to initiate a signature requirement or pick up option. In some instances, where no delivery plans of the set of delivery plans sufficiently reduces the risk level, the scheduling component 140 may select a security plan, terminating delivery of at least a portion of the packages and returning the delivery vehicle to a package depot or starting point of the delivery vehicle.

In operation 440, the communication component 150 notifies the one or more distributors of the modified delivery plan. In some embodiments, notification is performed based on modification of the delivery plan while the one or more distributors is in process of delivering packages from the second set of packages. In some instances, the communication component 150 notifies one or more of the distributors or delivery services and the designated recipients in a manner similar to or the same as described above with respect to the method 300.

Embodiments of the present disclosure, described above, may enable the package routing system 102 to identify an area with a thirty percent higher risk of theft for large screen televisions when delivered on a truck with a logo and identify the delivery service prior to the sunset. The package routing system 102 may then schedule delivery of those products after sunset which minimizes visibility of the package sitting outside and shortens a time until recipients arrive home. In another example, the package routing system 102 may identify that five percent of packages from a single delivery truck are being stolen prior to the recipient being home on a given day, within fifteen minutes of delivery as determined by tracking systems on the packages. The package routing system 102 may alert the delivery service and recipients that delivery signatures are requested or suggest a secondary delivery location. Further the package routing system 102 may enable recipients to accept risk for replacement. The package routing system 102 may also notify the delivery service to monitor future deliveries from that truck on that day. By way of further example, the package routing system 102 may determine that a single homeowner frequently reports items stolen from different suppliers though there is no similar pattern in the area. The package routing system 102 may determine that deliveries to that home must be signed and notify delivery services of the same.

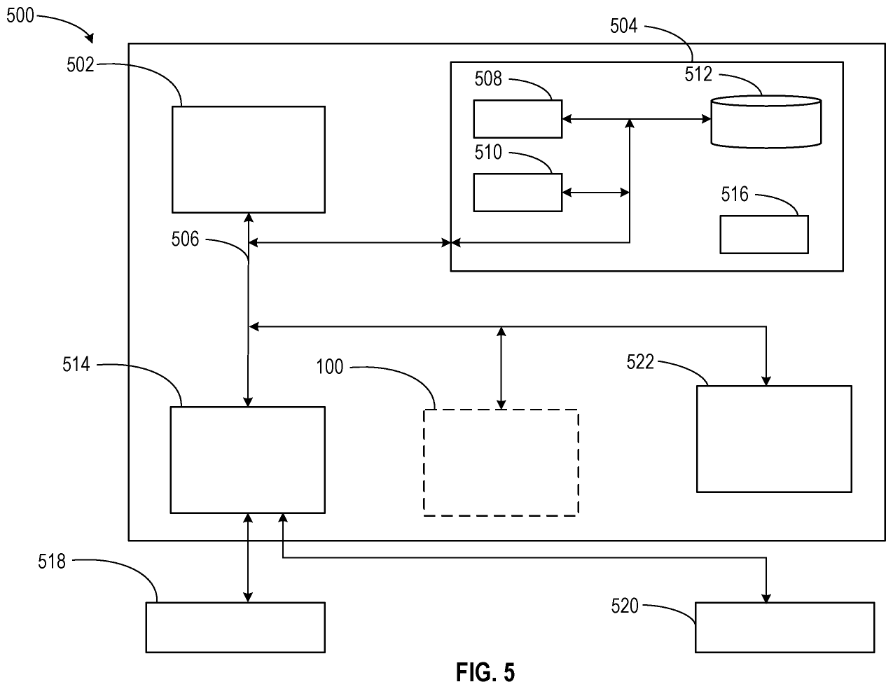

Embodiments of the present disclosure may be implemented together with virtually any type of computer, regardless of the platform being suitable for storing and/or executing program code. FIG. 5 shows, as an example, a computing system 500 (e.g., cloud computing system) suitable for executing program code related to the methods disclosed herein and for task deployment.

The computing system 500 is only one example of a suitable computer system and is not intended to suggest any limitation as to the scope of use or functionality of embodiments of the present disclosure described herein, regardless, whether the computer system 500 is capable of being implemented and/or performing any of the functionality set forth hereinabove. In the computer system 500, there are components, which are operational with numerous other general purpose or special purpose computing system environments or configurations. Examples of well-known computing systems, environments, and/or configurations that may be suitable for use with computer system/server 500 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 500 may be described in the general context of computer system-executable instructions, such as program modules, being executed by a computer system 500. Generally, program modules may include routines, programs, objects, components, logic, data structures, and so on that perform particular tasks or implement particular abstract data types. Computer system/server 500 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 500 is shown in the form of a general-purpose computing device. The components of computer system/server 500 may include, but are not limited to, one or more processors 502 (e.g., processing units), a system memory 504 (e.g., a computer-readable storage medium coupled to the one or more processors), and a bus 506 that couple various system components including system memory 504 to the processor 502. Bus 506 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 500 typically includes a variety of computer system readable media. Such media may be any available media that is accessible by computer system/server 500, and it includes both, volatile and non-volatile media, removable and non-removable media.

The system memory 504 may include computer system readable media in the form of volatile memory, such as random-access memory (RAM) 508 and/or cache memory 510. Computer system/server 500 may further include other removable/non-removable, volatile/non-volatile computer system storage media. By way of example only, a storage system 512 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 506 by one or more data media interfaces. As will be further depicted and described below, the system memory 504 may include at least one program product having a set (e.g., at least one) of program modules that are configured to carry out the functions of embodiments of the present disclosure.

The program/utility, having a set (at least one) of program modules 516, may be stored in the system memory 504 by way of example, and not limiting, as well as an operating system, one or more application programs, other program modules, and program data. Program modules may include one or more of the characteristic component 110, the tracking component 120, the risk component 130, the scheduling component 140, and the communication component 150, which are illustrated in FIG. 1. Each of the operating systems, one or more application programs, other program modules, and program data or some combination thereof, may include an implementation of a networking environment. Program modules 516 generally carry out the functions and/or methodologies of embodiments of the present disclosure, as described herein.

The computer system/server 500 may also communicate with one or more external devices 518 such as a keyboard, a pointing device, a display 520, etc.; one or more devices that enable a user to interact with computer system/server 500; and/or any devices (e.g., network card, modem, etc.) that enable computer system/server 500 to communicate with one or more other computing devices. Such communication can occur via Input/Output (I/O) interfaces 514. Still yet, computer system/server 500 may communicate with one or more networks such as a local area network (LAN), a general wide area network (WAN), and/or a public network (e.g., the Internet) via network adapter 522. As depicted, network adapter 522 may communicate with the other components of computer system/server 500 via bus 506. It should be understood that, although not shown, other hardware and/or software components could be used in conjunction with computer system/server 500. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

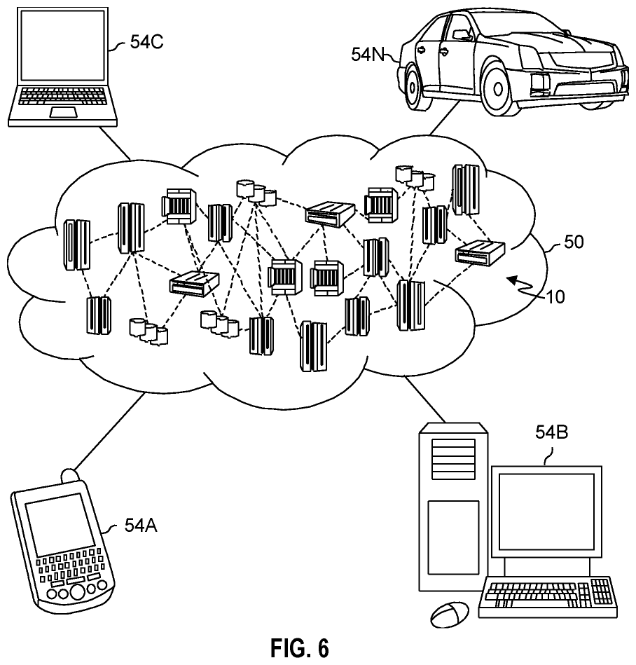

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

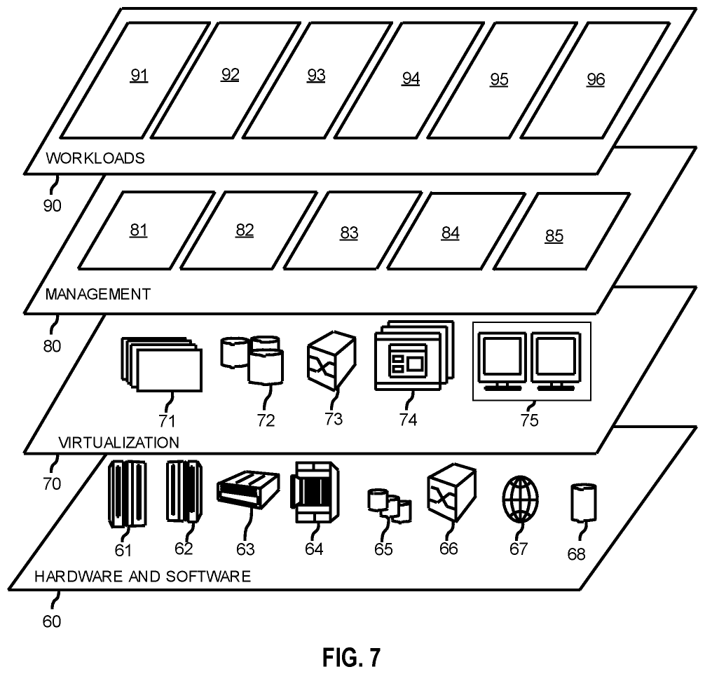

Referring now to FIG. 7, a set of functional abstraction layers provided by cloud computing environment 50 (FIG. 5) is shown. It should be understood in advance that the components, layers, and functions shown in FIG. 6 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and network traffic direction processing 96.

The descriptions of the various embodiments of the present disclosure have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer-readable storage medium (or media) having computer readable program instructions thereon for causing a processor to carry out aspects of the present invention.

The computer-readable storage medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

What is claimed is:

1. A computer-implemented method, comprising:
identifying a set of characteristics for a first set of packages delivered by one or more distributors;
identifying a subset of packages of the set of packages having a negative delivery status, the negative delivery status indicating a package undelivered to a designated recipient for the package;
based on the subset of packages with the negative delivery status, determining a risk matrix for package delivery by the one or more distributors;
based on the risk matrix, generating a set of delivery plans for delivery of a second set of packages by the one or more distributors, the second set of packages having a set of delivery characteristics; and
selecting a delivery plan from the set of delivery plans based on the risk matrix and the set of delivery characteristics of the second set of packages.

2. The computer-implemented method of claim 1, wherein determining the risk matrix further comprises:
determining a subset of common characteristics for the subset of packages having the negative delivery status; and
determining a delivery probability value for each characteristic of the subset of common characteristics.

3. The computer-implemented method of claim 2, wherein generating the set of delivery plans for the second set of packages further comprises:
determining one or more modifiable characteristics of the set of delivery characteristics for the second set of packages; and
for each delivery plan, determining a delivery probability for each package of the second set of packages based on the risk matrix and modification of at least one delivery characteristic.

4. The computer-implemented method of claim 1, further comprising:
generating a set of loading plans for organizing the second set of packages within a delivery vehicle, each loading plan of the set of loading plans corresponding with at least one delivery plan of the set of delivery plans; and
selecting a loading plan of the set of loading plans based on selection of the delivery plan.

5. The computer-implemented method of claim 1, further comprising:
based on selection of the delivery plan, modifying one or more delivery characteristics to generate modified delivery characteristics for at least a portion of the second set of packages.

6. The computer-implemented method of claim 5, further comprising
in response to modifying the one or more delivery characteristics, determining a designated recipient for each package of the portion of the second set of packages associated with the modified delivery characteristics;
for each package of the portion of the second set of packages, generating a change notification indicating the modified delivery characteristics for that package; and
transmitting the change notification for each package to the designated recipient associated with that package.

7. The computer-implemented method of claim 1, further comprising:
monitoring a delivery status of the second set of packages as the second set of packages are being delivered;
based on monitoring the delivery status, identifying a delivery anomaly indicating negative delivery of a portion of the second set of packages;
based on the delivery anomaly, modifying the delivery plan for the second set of packages to generate a modified delivery plan; and
notifying the one or more distributors of the modified delivery plan.

8. A system, comprising: one or more processors; and
a computer-readable storage medium, coupled to the one or more processors, storing program instructions that, when executed by the one or more processors, cause the one or more processors to perform operations comprising:
identifying a set of characteristics for a first set of packages delivered by one or more distributors;
identifying a subset of packages of the set of packages having a negative delivery status, the negative delivery status indicating a package undelivered to a designated recipient for the package;
based on the subset of packages with the negative delivery status, determining a risk matrix for package delivery by the one or more distributors;
based on the risk matrix, generating a set of delivery plans for delivery of a second set of packages by the one or more distributors, the second set of packages having a set of delivery characteristics; and
selecting a delivery plan from the set of delivery plans based on the risk matrix and the set of delivery characteristics of the second set of packages.

9. The system of claim 8, wherein determining the risk matrix further comprises:
determining a subset of common characteristics for the subset of packages having the negative delivery status; and
determining a delivery probability value for each characteristic of the subset of common characteristics.

10. The system of claim 9, wherein generating the set of delivery plans for the second set of packages further comprises:
determining one or more modifiable characteristics of the set of delivery characteristics for the second set of packages; and
for each delivery plan, determining a delivery probability for each package of the second set of packages based on the risk matrix and modification of at least one delivery characteristic.

11. The system of claim 8, wherein the operations further comprise:
generating a set of loading plans for organizing the second set of packages within a delivery vehicle, each loading plan of the set of loading plans corresponding with at least one delivery plan of the set of delivery plans; and
selecting a loading plan of the set of loading plans based on selection of the delivery plan.

12. The system of claim 8, wherein the operations further comprise:
based on selection of the delivery plan, modifying one or more delivery characteristics to generate modified delivery characteristics for at least a portion of the second set of packages.

13. The system of claim 12, wherein the operations further comprise:
in response to modifying the one or more delivery characteristics, determining a designated recipient for each package of the portion of the second set of packages associated with the modified delivery characteristics;
for each package of the portion of the second set of packages, generating a change notification indicating the modified delivery characteristics for that package; and
transmitting the change notification for each package to the designated recipient associated with that package.

14. The system of claim 8, wherein the operations further comprise:
monitoring a delivery status of the second set of packages as the second set of packages are being delivered;
based on monitoring the delivery status, identifying a delivery anomaly indicating negative delivery of a portion of the second set of packages;
based on the delivery anomaly, modifying the delivery plan for the second set of packages to generate a modified delivery plan; and
notifying the one or more distributors of the modified delivery plan.

15. A computer program product comprising a computer readable storage medium having program instructions embodied therewith, the program instructions being executable by one or more processors to cause the one or more processors to perform operations comprising:
identifying a set of characteristics for a first set of packages delivered by one or more distributors;
identifying a subset of packages of the set of packages having a negative delivery status, the negative delivery status indicating a package undelivered to a designated recipient for the package;
based on the subset of packages with the negative delivery status, determining a risk matrix for package delivery by the one or more distributors;
based on the risk matrix, generating a set of delivery plans for delivery of a second set of packages by the one or more distributors, the second set of packages having a set of delivery characteristics; and
selecting a delivery plan from the set of delivery plans based on the risk matrix and the set of delivery characteristics of the second set of packages.

16. The computer program product of claim 15, wherein determining the risk matrix further comprises:
determining a subset of common characteristics for the subset of packages having the negative delivery status; and
determining a delivery probability value for each characteristic of the subset of common characteristics.

17. The computer program product of claim 16, wherein generating the set of delivery plans for the second set of packages further comprises:
determining one or more modifiable characteristics of the set of delivery characteristics for the second set of packages; and
for each delivery plan, determining a delivery probability for each package of the second set of packages based on the risk matrix and modification of at least one delivery characteristic.

18. The computer program product of claim 15, wherein the operations further comprise:
based on selection of the delivery plan, modifying one or more delivery characteristics to generate modified delivery characteristics for at least a portion of the second set of packages.

19. The computer program product of claim 18, wherein the operations further comprise:
in response to modifying the one or more delivery characteristics, determining a designated recipient for each package of the portion of the second set of packages associated with the modified delivery characteristics;
for each package of the portion of the second set of packages, generating a change notification indicating the modified delivery characteristics for that package; and
transmitting the change notification for each package to the designated recipient associated with that package.

20. The computer program product of claim 15, wherein the operations further comprise:
monitoring a delivery status of the second set of packages as the second set of packages are being delivered;
based on monitoring the delivery status, identifying a delivery anomaly indicating negative delivery of a portion of the second set of packages;
based on the delivery anomaly, modifying the delivery plan for the second set of packages to generate a modified delivery plan; and
notifying the one or more distributors of the modified delivery plan.
